(19) United States
(12) Patent Application Publication
(10) Pub. No.: US 2019/0249060 A1
(43) Pub. Date: Aug. 15, 2019

(54) COMPOSITION FOR A SOLID MATRIX USED IN CONNECTION WITH HANDLING BULK MATERIALS

(71) Applicant: ProAction Fluids LLC, Shreveport, LA (US)

(72) Inventors: Nathan R. Hutchings, Shreveport, LA (US); Paxton Monsour, Shreveport, LA (US); Ryan Humphrey, Shreveport, LA (US)

(21) Appl. No.: 16/257,579

(22) Filed: Jan. 25, 2019

Related U.S. Application Data
(60) Provisional application No. 62/629,140, filed on Feb. 12, 2018.
(60) Provisional application No. 62/663,869, filed on Apr. 27, 2018.

(51) Int. Cl. C09K 8/035; C09K 8/516; C09K 8/508

(52) U.S. Cl. CPC C09K 8/035; C09K 8/5086; C09K 8/5083; C09K 8/516

(57) ABSTRACT

A composition for fluid additives that includes at least one water soluble polymer having a predetermined melting temperature. The polymer has mixed therein a selected amount of at least one powdered fluid additive when at least one soluble polymer is held at or above the predetermined melting temperature and is subsequently cooled to solidify. The predetermined temperature is greater than a maximum expected temperature to which the composition will be exposed prior to use of the composition.

### CROSS REFERENCE TO RELATED APPLICATIONS

Priority is claimed from U.S. Provisional Application No. 62/663,869 filed on Feb. 22, 2018 and U.S. Provisional Application No. 62/629,140 filed on Feb. 12, 2018. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of wellbore drilling and wellbore completion fluid additives used in the oil and gas extraction industry and in the horizontal direction drilling industry. More specifically, the disclosure relates to composition of a solid matrix used in connection with fluid additives to reduce hazardous waste and dust when such additives would otherwise be used in powdered form.

Wellbore drilling and completion fluids include additives such as polyacrylamide, 2-Acrylamido-2-methylpropane sulfonic acid (AMPS) containing polymers or copolymers, sodium polyacrylate polymers, acrylamide/sodium acrylate copolymer (e.g. 2-Propenamide polymer), xanthan, guar, bentonite, barite, polyanionic cellulose, surfactants, biocides, and the like. The additives are often packaged and delivered into a treatment fluid at the well construction site or bore-site as powdered solids or as oil-based liquid emulsions or suspensions. Other industries such as potable water-treatment, waste-water treatment, industrial heating/cooling/boiler systems, and solid waste treatment also use similar additives as rheology modifiers, flocculents, or fluid treatment chemicals.

Using the foregoing additives in the form of powders may be messy, difficult to accurately dispense, potentially hazardous to the health of the workers handling the bags and working amidst dust, and may make mixing difficult and time consuming. Liquid slurries are seldom more than 35% active ingredient which makes them logistically inconvenient and inefficient. Further, rheology modifiers are often oil-based products which may restrict the use of such additives where oils or components of the suspension/emulsion system are undesirable in the treatment fluid system or waste created therefrom. With both powders and liquid treatment chemicals, packaging waste and residual material within the waste packaging can be a safety hazard, may be inconvenient to store and may be cost inefficient.

Therefore, an environmentally-friendly, safe, completely soluble, and dustless composition of bulk solids that can be conveniently packaged with minimal waste and residual material to carry the additives would be advantageous, particularly for mobile/decentralized processes where handling chemical additives occurs away from permanent processing plants/locations.

### DETAILED DESCRIPTION

A composition for a solid matrix used in connection with handling bulk materials may comprise at least one water-soluble polymer that has a predetermined melting point at least equal to the highest expected ambient temperature to which the polymer may be subjected during storage, handling and transportation to the place of use. In some embodiments, the predetermined temperature may be above 100° F. The water-soluble polymer may be combined with at least one fluid treatment additive powder by melting the water-soluble polymer and mixing in the desired additive powder(s) such that the powdered additive(s) comprise between 20% and 80% by weight of the combined fluid additive(s) and melted water-soluble polymer. The foregoing mixture may then be dispensed into a form or mold and then cooled below the predetermined temperature to form a solid.

The water-soluble polymer may comprise, for example and without limitation, polyethylene glycol (PEG) with a molecular weight of at least 1000 Daltons, more specifically, PEG-1000 to PEG-8000 or combinations thereof to obtain a predetermined melting temperature of the water-soluble polymer or mixture of polymers.

In some embodiments, other water-soluble polymers with melting points in a suitable range may include poly(2-ethyl-2-oxazoline), agarose, gelatin, or any combination thereof or the like.

The powdered fluid additive may be any material or mixture of materials that changes rheological and/or chemical properties of a fluid in which the additive is to be mixed.

In one embodiment, PEG-1450 is melted at 43.5° C. (110° F.) and combined with 13% by weight (wt) water to form a liquid solution of 87% (wt) PEG-1450. The PEG-1450 solution is held at a temperature above 43° C. (100° F.) until one or more selected additives are incorporated in to the mixture and subsequently poured or pressed into a form or mold.

The foregoing solution may be combined with at least one fluid treatment additive including but not limited to polyacrylamide, 2-Acrylamido-2-methylpropane sulfonic acid (AMPS) containing polymers or copolymers, sodium polyacrylate polymers, acrylamide/sodium acrylate copolymer (e.g. 2-Propenamide polymer), xanthan, guar, bentonite, barite, polyanionic cellulose, modified cellulose polymers, modified guar polymers, surfactants, detergents, biocides, corrosion inhibitors, chelators, pH modifiers, buffers, plasticizers, extenders, cross-linkers, gel-breakers, oxygen scavengers, lost circulation materials, proppant, and other powdered drilling, completion, or HDD fluid additives known to those skilled in the art. Additionally, the use of excipient additives that enhance the aesthetic, appearance, texture, or rate of dissolution, such as but not limited to, dyes, simple sugars, salts, and the like, may be incorporated into the embodiments and are contemplated within the scope of the invention.

In one embodiment, to create a high gel-strength/high yield point composition suitable for suspending sand, gravel, grout, cement, or other high density solids, the composition may comprise 45% (wt) PEG-1450 melt combined with 35% (wt) acrylamide/sodium acrylate copolymer (e.g. 2-Propenamide polymer) and 20% (wt) Xanthan Gum powder.

In another example embodiment, to create a gelled drilling fluid base, the composition comprises 40% (wt) PEG-1450 melt combined with 60% (wt) high-yield sodium bentonite.

In another example embodiment to create a thixotropic rheology modifier, the composition comprises 50% (wt) PEG-1450 melt combined with 50% xanthan powder.

In another example embodiment, to create a drilling or completion rheology modifier for suspending low-density solids, the composition comprises 55% (wt) PEG-1450 melt combined with 45% acrylamide/sodium acrylate copolymer (e.g. 2-Propenamide polymer) polymer.

In another example embodiment, to a create a drilling fluid additive for moderately permeable soil matrices (e.g., “loamy” soils), the composition comprises 50% (wt) PEG-1450 melt combined with 28% (wt) acrylamide/sodium acrylate copolymer (e.g. 2-Propenamide polymer), 18% (wt) xanthan powder, and 4% (wt) sodium tripolyphosphate.

In another example embodiment, to create an additive for low density/low permeability (e.g. “clayey” soils), the composition comprises 50% (wt) PEG-1450 melt combined with 35% (wt) anionic polyacrylamide polymer, 5% (wt) sodium tripolyphosphate, 10% 2-hydroxyethyl trimethyl-ammonium chloride (i.e., choline chloride).

Other embodiments may include individual or combinations of well-known fluid system treatment ingredients that can be incorporated in to the water-soluble polymer melt and formed into an appropriately shaped solid so as to eliminate the need to handle the material as a loose powder or as a liquid suspension or emulsion and/or to enable the shaped solid to specifically fit into a particular mechanical-fluid interface device

The present disclosure further relates to a method wherein the composition described above is poured or pressed into a mold or form. In some embodiments, the mold or form may cause the composition to solidify into a shape having a single, contiguous exterior surface enclosing the entire volume of the shape. In some embodiments, the shape may comprise more than one contiguous exterior surface, that is, the shape may define an exterior surface having embedded features, such as surface area modifiers, through passages, perforations and the like to increase the effective surface area above that of the same shape having a single, contiguous surface.

In some embodiments the mold or form having a single, contiguous external surface may be in the shape of a puck or brick containing between 0.1 and 50 pounds of fluid additive mixed into the polymer/water mixture and cooled below the predetermined temperature to become substantially solid. The solid can then be handled, packaged, and transported as a solid object or packaged into containers for use as, e.g., a fluid additive, rheology modifier, or water-treatment chemical. Any otherwise shaped mold or form for the composition is within the scope the method of molding the composition into a solid object, including those configured to fit into a specific container shape, feeder system, keyway, or other shape designed to control the mechanical-chemical interface and use of a fluid composition made by mixing the composition into a particular fluid to obtain selected fluid properties.

In one example embodiment, 5 gallons of the composition may be dispensed into a 4″×96″ cylinder, cooled and subsequently cut into eight 12″ cylinders each containing between 3 and 8 pounds of additives in the molded solid. In another example embodiment, the composition is molded into a 4″×4″×8″ rectangular brick, which may have several 1″ through-holes to increase surface area of the molded composition when introduced into a fluid system.

The disclosure further relates to a method wherein the puck or brick (or other molded solid) is then added to a liquid tank, circulating pipe system, or other point of entry to a fluid system so that the water soluble polymer within the molded composition may be dissolved into the fluid system, thereby releasing the additive(s) to serve their respective function(s) within the fluid system.

To accelerate the dissolution and/or dispersion of the molded composition, the molded composition may be mechanically decomposed (e.g. by grinding, smashing, pulverization, etc.) as it is introduced into a fluid system to increase the surface area.

In some embodiments, to accelerate the dissolution and/or dispersion of the molded composition, the molded composition may be introduced into a water-jet, agitator, or other high-velocity turbulent fluid interface.

In some embodiments, to accelerate the dissolution and/or dispersion of the composition, the molded composition may be heated and/or melted at the point of introduction into the fluid system.

In some embodiments, combinations of methods to accelerate the dissolution and/or dispersion of the molded composition may be used concurrently or sequentially.

In an example embodiment, the molded composition as described above may be inserted into a “Tee” on the suction side of a centrifugal pump that is circulating water warmed by a heat exchanger into a reservoir tank. The rate of dissolution may be controlled by regulating the temperature and flow rate of the circulating fluid, and the fluid in the reservoir tank is used as the treatment fluid or portion of the treatment fluid containing the respective chemical additives.

In another example embodiment, the molded composition may be inserted into a chamber, on the bottom of which is a rotating grinder. The chamber and grinder may be suspended over a circulating fluid reservoir, and the ground molded composition is introduced into the reservoir by gravity as it is exits the grinder. Alternatively, the wet-grinder may be inserted into the flow path where the molded solid and fluid are introduced one another. The circulating fluid enhances dissolution of the ground, molded composition, thereby releasing the additive(s) into the fluid system.

In another example embodiment, the molded composition is placed into a sealed chamber with several high pressure and/or high velocity water jets oriented toward the introduced molded solid. The chamber drains into a reservoir or directly feeds the suction side of a circulating pump. High pressure, high velocity fluids discharged from the pump accelerate dissolution of the molded composition and introduce the dispersed additive(s) into the fluid system.

In any of the foregoing example embodiments, the concentration and/or dosage of the fluid additive(s) may be monitored or metered using well known volume or weight measurement devices which may in some embodiments be linked to a process controller, such as a programmable logic controller (PLC) having instructions thereon to control the rate of addition and/or concentration of the composition.

In some embodiments, combinations of multiple products may be used concurrently or subsequently into a single fluid system.

In some embodiments, combinations of multiple delivery systems may be used concurrently or subsequently into a single fluid system.

The compositions and methods described herein are contemplated to be able to accommodate future compositions of industrial treatment chemicals that are not yet known at the time of this disclosure.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A composition for fluid additives, comprising:
at least one water soluble polymer having a predetermined melting temperature having mixed therein a selected amount of at least one powdered fluid additive when the water soluble polymer is held at or above the predetermined melting temperature and is subsequently cooled to solidify, the at least one powdered fluid additive comprising a material that changes a rheological and/or chemical property of a fluid into which the at least one powdered fluid additive is mixed; and
wherein the predetermined temperature is greater than a maximum expected temperature to which the composition will be exposed prior to use of the composition.

2. The composition of claim 1 wherein the at least one water-soluble polymer comprises polyethylene glycol.

3. The composition of claim 2 wherein the polyethylene glycol has a molecular weight of at least 1000 Daltons.

4. The composition of claim 3 wherein the polyethylene glycol comprises molecular weight combinations to obtain the predetermined melting temperature.

5. The composition of claim 1 wherein the at least one water soluble polymer comprises at least one of poly(2-ethyl-2-oxazoline), agarose, gelatin, and combination thereof.

6. The composition of claim 1 wherein the at least one powdered fluid additive comprises at least one of polyacrylamide, 2-Acrylamido-2-methylpropane sulfonic acid (AMPS) containing polymers or copolymers, sodium polyacrylate polymers, acrylamide/sodium acrylate copolymer (e.g. 2-Propenamide polymer), xanthan gum, guar gum, bentonite, barite, polyanionic cellulose, modified cellulose polymers, modified guar polymers, surfactants, detergents, biocides, corrosion inhibitors, chelators, pH modifiers, buffers, plasticizers, extenders, cross-linkers, gel-breakers, oxygen scavengers, lost circulation materials, and proppant and mixtures thereof.

7. The composition of claim 1 wherein the at least one powdered fluid additive comprises at least one of a viscosity-modifying agent, a gel strength modifying agent, a surface-tension modifying agent, a clay control additive, a pH modifying agent, and a colloidal solid.

8. The composition of claim 1 wherein the composition comprises by weight 45 percent water-soluble polymer, 35 percent acrylamide/sodium acrylate copolymer (e.g. 2-Propenamide polymer) containing polymer and 20 percent xanthan gum.

9. The composition of claim 1 wherein the composition comprises by weight 20 to 40 percent water-soluble polymer and 60 to 80 percent sodium bentonite.

10. The composition of claim 1 wherein the composition comprises by weight 50 percent water-soluble polymer and 50 percent xanthan powder.

11. The composition of claim 1 wherein the composition comprises by weight 35 to 55 percent water-soluble polymer and 45 to 65 percent acrylamide/sodium acrylate copolymer (e.g. 2-Propenamide polymer).

12. The composition of claim 1 wherein the composition comprises by weight 50 percent water-soluble polymer and 28 percent acrylamide/sodium acrylate copolymer (e.g. 2-Propenamide polymer), 18 percent xanthan powder, and 4 percent sodium tripolyphosphate.

13. The composition of claim 1 wherein the composition comprises by weight 50 percent water-soluble polymer 35 percent acrylamide/sodium acrylate copolymer (e.g. 2-Propenamide polymer), 5 percent sodium tripolyphosphate and 10 percent 2-hydroxyethyl trimethyl-ammonium (aka Choline) chloride.

14. A method for making a fluid additive, comprising:
heating at least one water soluble polymer to at least a predetermined melting temperature;
mixing into the at least one heated water soluble polymer a selected amount of at least one powdered fluid additive, the at least one powdered fluid additive comprising a material that changes a rheological and/or chemical property of a fluid into which the at least one powdered fluid additive is mixed;
dispensing the at least one water soluble polymer and the at least one mixed powdered fluid additive into a form; and
cooling the dispensed at least one water soluble polymer and mixed at least one powdered fluid additive to solidify at least one soluble polymer and mixed powdered fluid additive.

15. The method of claim 14 wherein the at least one-soluble polymer comprises polyethylene glycol.

16. The method of claim 15 wherein the polyethylene glycol has a molecular weight of at least 1000 Daltons.

17. The method of claim 16 wherein the polyethylene glycol comprises molecular weight combinations to obtain the predetermined melting temperature.

18. The method of claim 14 wherein the at least one water soluble polymer comprises at least one of poly(2-ethyl-2-oxazoline), agarose, gelatin, and combination thereof.

19. The method of claim 14 wherein the at least one powdered fluid additive comprises at least one of polyacrylamide, 2-Acrylamido-2-methylpropane sulfonic acid (AMPS) containing polymers or copolymers, sodium polyacrylate polymers, acrylamide/sodium acrylate copolymer (e.g. 2-Propenamide polymer), xanthan gum, guar gum, bentonite, barite, polyanionic cellulose, modified cellulose polymers, modified guar polymers, surfactants, detergents, biocides, corrosion inhibitors, chelators, pH modifiers, buffers, plasticizers, extenders, cross-linkers, gel-breakers, oxygen scavengers, lost circulation materials, and proppant and mixtures thereof.

20. The method of claim 14 wherein the at least one powdered fluid additive comprises at least one of a viscosity modifying agent, a gel strength modifying agent and a surface-tension modifying agent, a clay control additive, a pH modifying agent, and a colloidal solid.

21. The method of claim 14 wherein the composition comprises by weight 45 percent water-soluble polymer, 35 percent acrylamide/sodium acrylate copolymer (e.g. 2-Propenamide polymer) and 20 percent xanthan gum.

22. The method of claim 14 wherein the composition comprises by weight 40 percent water-soluble polymer and 60 percent sodium bentonite.

23. The method of claim 14 wherein the composition comprises by weight 50 percent water-soluble polymer and 50 percent xanthan powder.

24. The method of claim 14 wherein the composition comprises by weight 55 percent water-soluble polymer and 45 percent acrylamide/sodium acrylate copolymer (e.g. 2-Propenamide polymer).

25. The method of claim 14 wherein the composition comprises by weight 50 percent water-soluble polymer and 28 percent acrylamide/sodium acrylate copolymer (e.g. 2-Propenamide polymer), 18 percent xanthan powder, and 4 percent sodium tripolyphosphate.

26. The method of claim 14 wherein the composition comprises by weight 50 percent water-soluble polymer 35 percent acrylamide/sodium acrylate copolymer (e.g. 2-Propenamide polymer), 5 percent sodium tripolyphosphate and 10 percent 2-hydroxyethyl trimethyl-ammonium chloride.
